(19) United States
(12) Patent Application Publication
(10) Pub. No.: US 2007/0248391 A1
(43) Pub. Date: Oct. 25, 2007

(54) IMAGE FORMING APPARATUS WITH SHEET GUIDING UNIT BETWEEN TRANSFERING UNIT AND FIXING UNIT

(76) Inventors: Nobuto Yokokawa, Yokohama-shi (JP); Mitsuru Takahashi, Kawasaki-shi (JP); Kazuchika Saeki, Atsugi-shi (JP); Kazuosa Kuma, Yokohama-shi (JP); Tsutomu Katoh, Kawasaki-shi (JP); Takeshi Fukao, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/739,391

(22) Filed: Apr. 24, 2007

(30) Foreign Application Priority Data
Apr. 24, 2006 (JP) 2006-118724

(51) Int. Cl. G03G 15/00

(52) U.S. Cl. 399/400

(57) ABSTRACT

An image forming apparatus includes a guiding unit. This guiding unit is located between a transferring unit and a fixing unit and includes a guiding part. The guiding part guides a recording sheet from the transferring unit to the fixing unit with a side opposite to the surface of the recording sheet contacting with the guiding part. The guiding part has a greater height at end portions than at a central portion thereof.

### CROSS-REFERENCE TO RELATED APPLICATION

This patent specification is based on Japanese patent application No. 2006-118724 filed on Apr. 24, 2006 in the Japan Patent Office, the entire contents of which are incorporated by reference herein.

### BACKGROUND OF INVENTION

1. Field of the Invention

The present disclosure generally relates to an image forming apparatus, such as a copy machine, a printer, a facsimile machine, and a multi-function machine capable of copying, printing, and faxing, and more particularly to an image forming apparatus including a guiding unit between a transferring unit and a fixing unit that guides a recording sheet from the transferring unit to the fixing unit.

2. Description of the Background Art

Toner scatter from a toner image on a record sheet can occur between a transferring unit and a fixing unit in an image forming apparatus. The toner scattering makes an output quality of a toner image deteriorate. To prevent toner from the toner image from scattering, an image forming apparatus is disclosed in Laid-open Japanese Patent Application No. 2002-182491. The image forming apparatus includes an electric discharge member, which discharges static electricity from a recording sheet after passing a transferring unit, and is unified with a sheet guiding plate equipped between the transferring unit and the fixing unit.

### SUMMARY OF THE INVENTION

According to an aspect of the present invention, an image forming apparatus includes a guiding unit. The guiding unit is located between a transferring unit and a fixing unit, and includes a guiding part. The guiding part guides a recording sheet from the transferring unit to the fixing unit with a side opposite to the surface of the recording sheet contacting with the guiding part. The guiding part has a greater height at end portions than at a central portion.

### BRIEF DESCRIPTION OF THE DRAWINGS

A more complete appreciation of exemplary aspects of the present invention and many of the attendant advantage thereof will be readily obtained as the same becomes better understood by reference to the following detailed description when considered in connection with the accompanying drawings, wherein:

FIG. 1 is a schematic diagram illustrating a printer according to an exemplary embodiment of the present invention in which one sheet guiding unit of either first, second, third, or fourth embodiments is alternatively equipped;

FIG. 2 is an orthogonal cross section of a guiding unit of a first embodiment of a sheet guiding unit of the present invention in the direction of conveying the recording sheet;

FIG. 3 is an orthogonal cross section of a guiding unit of a second embodiment of a sheet guiding unit of the present invention in the direction of conveying the recording sheet;

FIG. 4 is a chart of the relationship between an incidence ratio of image deterioration with abnormal discharge, an incidence ratio of making the recording sheet crease, and a difference between a height of higher end portions than at a central portion of the guiding unit;

FIG. 5 is an orthogonal cross section of a guiding unit of a third embodiment of a sheet guiding unit of the present invention in the direction of conveying the recording sheet;

FIG. 6A is a part diagram in which the side end of the recording sheet contacts the guiding unit of FIG. 3;

FIG. 6B is a part diagram in which the side end of the recording sheet contacts the guiding unit of FIG. 5;

FIG. 7 is an orthogonal cross section of a guiding unit of a fourth embodiment of a sheet guiding unit of the present invention in the direction of conveying the recording sheet;

FIG. 8A is a diagram representing one position of a cam;

FIG. 8B is a diagram representing another position of a cam;

FIGS. 9A, 9B, 10A, 10B, and 10C are views showing toner shapes diagrammatically.

### DESCRIPTION OF PREFERRED EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, image forming apparatuses according to exemplary embodiments of the present invention are described.

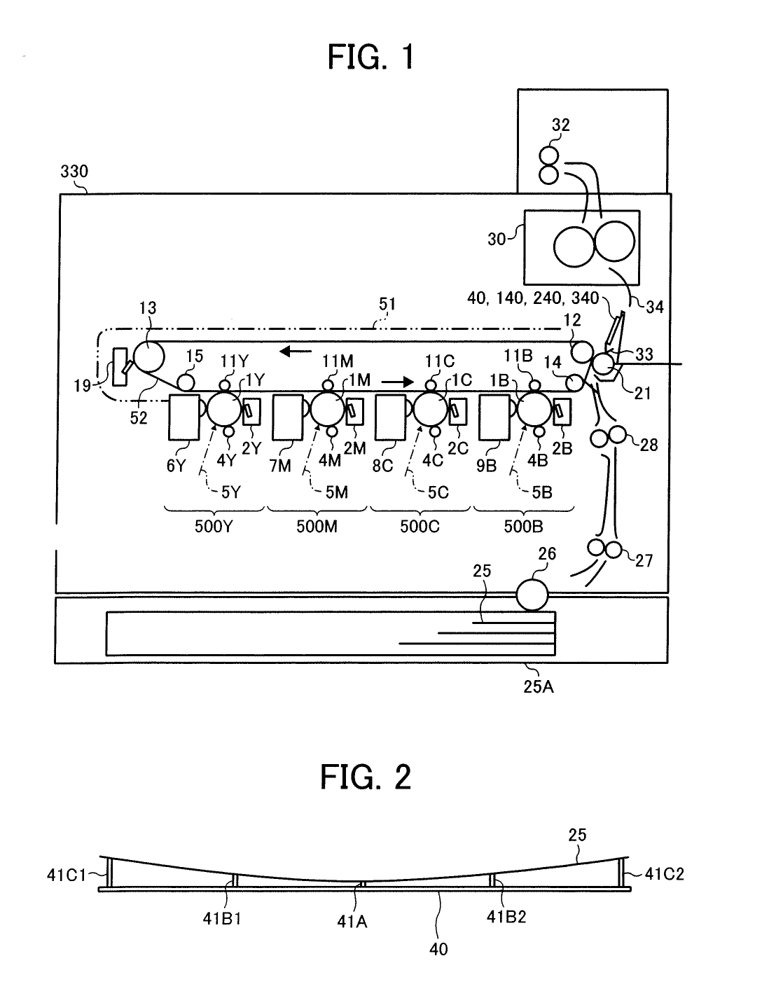

Referring to FIG. 1, a printer employing an electrophotographic method with a tandem system includes image forming units 500B, 500M, 500C, and 500Y, an intermediate transfer belt unit 51, a secondary transfer roller 21, a recording sheet 25, a sheet storing case 25A, a feed roller 26, a pair of conveyance rollers 27, registration rollers 28, a discharge member 33, a subordinate guiding member 34, a guiding unit 40, a fixing unit 30, ejection rollers 32, and an upper tray 330. The image forming units 500B, 500M, 500C, and 500Y have the same structure except for their toner component. The image forming units 500B, 500C, 500M, and 500Y are disposed for respective four color components, black, cyan, magenta, and yellow which are abbreviated as B, C, M, and Y, respectively. These color abbreviations may be omitted as necessary throughout the several views. The image forming unit 500B includes a photoconductor 1B, a cleaning unit 2B, a charging unit 4B, and a development unit 9B. The other three image forming units 500C, 500M, 500Y have corresponding components as the image forming unit 500B.

The intermediate transfer belt unit 51 includes an intermediate transfer belt 52, transfer bias rollers 11B, 11M, 11C, and 11Y, a driving roller 12, a tension roller 13, a first driven roller 14, a second driven roller 15, and a belt cleaning unit 19.

A detailed description of the structure of the intermediate transfer belt unit 51 is now provided. As shown in FIG. 1, the intermediate transfer belt 52 extends across the driving roller 12, tension roller 13, and first and second driven rollers 14 and 15. The driving roller 12 is disposed opposing the secondary transfer roller 21, which is disposed opposing a front-surface of the intermediate transfer belt 52. The image forming units 500B, 500M, 500C, and 500Y are disposed below the intermediate transfer belt 52 along a belt movement direction. The intermediate transfer belt 52 has the transfer bias rollers 11B, 11M, 11C, and 11Y at a back-surface thereof so that the transfer bias rollers 11B, 11M, 11C, and 11Y are disposed opposing the photoconductors 1B, 1M, 1C, and 1Y, respectively. The tension roller 13 provides tension to the intermediate transfer belt 52. The first and second driven rollers 14 and 15 support the intermediate transfer belt 52 so as to rotate the transfer belt 52. The belt cleaning unit 19 removes remaining toner from the intermediate transfer belt 52 after the toner images are secondarily transferred onto the recording sheet 25. The intermediate transfer belt unit 51 also includes a frame (not shown) that may hold the belt cleaning unit 19. Alternatively, the belt cleaning unit 19 may be held by a main body of the image forming apparatus.

Now follows a description of the process of toner image forming by the image forming units 500B, 500M, 500C, and 500Y respectively. At first, the charging units 4B, 4M, 4C, and 4Y uniformly charge surfaces of the photoconductors 1B, 1M, 1C, and 1Y, respectively. The photoconductors 1B, 1M, 1C, and 1Y form the electrostatic latent images thereon by irradiation of lights applied from an optical writing unit (not shown). The lights from the optical writing unit are indicated as 5B, 5M, 5C, and 5Y with arrows in FIG. 1. The development units 9B, 9M, 9C, and 9Y develop the electrostatic latent images on the photoconductors 1B, 1M, 1C, and 1Y respectively, to form the toner images. The intermediate transfer belt unit 51 transfers the toner images from the photoconductors 1B, 1M, 1C, and 1Y onto the intermediate transfer belt 52. The four toner images are superimposed one on another to form a full color toner image on the intermediate transfer belt 52. The full color toner image is then transferred onto a recording sheet 25 at the secondary transfer roller 21. Then, to prepare for forming a next toner image, the cleaning units 2B, 2M, 2C, and 2Y remove remaining toner from the photoconductors 1B, 1M, 1C, and 1Y, respectively, after the full color toner image is transferred onto the recording sheet 25 by the secondary transfer roller 21.

Now a description of the process of the intermediate transfer belt unit 51 to form a full color toner image on the intermediate transfer belt 52 is provided. The transfer bias rollers 11B, 11M, 11C, and 11Y transfer the four toner images on photoconductors 1B, 1M, 1C, and 1Y, respectively, onto the intermediate transfer belt 52 with an electric transfer power of a bias voltage. Each toner image is transferred one by one, and superimposed one on another. When the transfer bias roller 11Y finishes transfer of the yellow toner image, which is the fourth toner image, onto the intermediate transfer belt 52, a full color toner image is formed on the belt 52 completely.

Now a description of the process of conveying the recording sheet 25 from the sheet storing case 25A to the upper tray 330 is provided. A stack of the recording sheets 25 is stocked in the sheet storing case 25A, which is shown below the main body of the printer. The feed roller 26 located above the sheet storing case 25A picks up each recording sheet 25 one by one and feeds the recording sheet 25 to the pair of conveyance rollers 27. The pair of conveyance rollers 27, located above the feed roller 26, conveys the recording sheet 25 towards the registration rollers 28. The registration rollers 28, located above the pair of conveyance rollers 27, register the recording sheet 25 to correspond with the full color toner image on the intermediate transfer belt 52. The secondary transfer roller 21 is located above the registration rollers 28 and opposed to the intermediate transfer belt 52. The secondary transfer roller 21 transfers the full color toner image from the intermediate transfer belt 52 to the recording sheet 25, which is conveyed by the registration rollers 28. The discharge member 33 located proximately above the secondary transfer roller 21 discharges static electricity from the recording sheet 25.

The guiding unit 40 located proximately above the discharge member 33 guides the recording sheet 25 from the intermediate transfer belt 52 to the fixing unit 30 via the subordinate guiding member 34. The subordinate guiding member 34 located above the guiding unit 40 guides the recording sheet 25 to the fixing unit 30. If the guiding unit 40 is close to the fixing unit 34, the subordinate guiding member 34 may not be needed. The fixing unit 30 fixes the full color toner image on the recording sheet 25 with heat and pressure. The ejection rollers 32 eject the recording sheet 25 on which the toner images are fixed to the upper tray 33.

The fixing unit 30 includes a pair of rollers, including a fusing roller and a pressure roller. The pair of rollers in the fixing unit 30 can rotate more slowly than the secondary transfer roller 21 so that the recording sheet 25 gradually bends between the secondary transfer roller 21 and the fixing unit 30 after the top end of the recording sheet passes a contact area between the fixing roller and the pressure roller. Accordingly, the guiding unit 40 contacts the side opposite to the surface of the bent part of the recording sheet 25.

An explanation is now provided why toner scattering generally happens when a recording sheet is guided from a transferring unit to a fixing unit. A guiding member located between the transferring unit and the fixing unit guides the recording sheet with a side opposite to the surface of the recording sheet contacting with the guiding member. At that time, the recording sheet charges the guiding member with friction. The charging volume increases every time a recording sheet passes on the guiding member. When the volume surpasses a limit of keeping static electricity within the guiding member, an abnormal discharge occurs between the guiding member and the recording sheet and the discharge makes the toner scatter on the surface of the recording sheet. When the image forming apparatus outputs a large number of sheets continuously, the abnormal discharge is apt to occur.

The function and effect of the image forming apparatus in the foregoing background art is now provided. The image forming apparatus includes certain electric discharge members on the guiding unit. The electric discharge members discharge the static electricity from the recording sheet to prevent the guiding plate from being charged up by the recording sheet. To stabilize discharge by the discharge member, the discharge member should maintain a certain distance from the recording sheet. Accordingly, the electric discharge member of the background art is unitarily formed with a sheet guiding plate that is located between the transferring unit and the fixing unit. When the sheet guiding plate conveys the recording sheet with a side opposite to the surface of the recording sheet contacting with the guiding plate, the discharge members also contact the recording sheet while maintaining a certain distance from the sheet. However, charging up by friction for the guiding plate occurs from contact with the recording sheet. If the charging volume is greater than the discharging volume, at last, in the sheet guiding unit the abnormal discharge to the recording sheet may occur, which is in the opposite direction of the discharge with the discharge member.

Now a description of the effect of the appearance of toner scattering is provided. In general, most image forming apparatuses form an image with some margin on both side ends of the recording sheet. Accordingly, if an abnormal discharge from the guiding member occurs at the width end margins of the recording sheet, the toner scattering will not occur, because there is almost no toner on the width ends. Even if image forming apparatus forms a toner image without any margin at both width ends of the recording sheet, toner scattering occurring at the width end areas does not stand out more than the one occurring at the central area of the recording sheet. The guiding unit 40 of a first embodiment of the present invention described in FIG. 2 takes advantage of the effect described above to maintain the image quality on the recording sheet.

As shown in FIG. 2, the guiding unit 40 includes guiding ribs 41A, 41B1, 41B2, 41C1, and 41C2 to contact the recording sheet 25, and which guide the recording sheet 25 from the intermediate transfer belt 52 to the fixing unit 30. The five guiding ribs stand in line orthogonal to the conveying direction of the recording sheet and extend in the direction of conveying the recording sheet 25 respectively. The five guiding ribs are composed according to a rule that the outer ribs are higher in height than the inner ribs. That is, the outermost guiding ribs 41C1 and 41C2 are the highest of the five ribs, the guiding rib 41A, which is located at the center of the guiding unit 40, is the lowest of the five ribs, and the guiding ribs 41B1 and 41B2, which are located between the highest ribs 41C1, 41C2 and the lowest rib 41A are of intermediate height.

The printer of FIG. 1 can output different size recording sheets, for example an A3 sheet and A4 sheet. The A3 sheet is typically output in the portrait direction. The A4 sheet is typically output in both the portrait direction and landscape direction. The rib 41A guides all size recording sheets in contact with substantial center areas of the side opposite to the surface of the recording sheets. The ribs 41B1 and 41B2 guide the A4 recording sheet in contact with substantial width end areas of the side opposite to the surface of the recording sheets in the portrait direction. The ribs 41C1 and 41C2 guide the A4 recording sheet in contact with substantial width end areas of the side opposite to the surface of the recording sheets in the landscape direction. The ribs 41C1, 41C2 also guide the A3 recording sheet in contact with substantial width end areas of the side opposite to the surface of the recording sheets in the portrait direction.

The description of the function of the guiding unit 40 is now provided. When the guiding unit 40 guides the A4 recording sheet in the portrait direction to the subordinate guiding member 34, the A4 recording sheet is in contact with the rib 41A, rib 41B1, and rib 41B2. The A4 sheet is bent in the width direction orthogonal to the conveying direction of the sheet by the difference of the height between the rib 41A and the ribs 41B1, 41B2. The width end area of the A4 sheet presses strongly against the ribs 41B1 and 41B2 by a spring back force of the bending sheet that tries to stabilize the sheet to a flat position, while the central area of the A4 sheet presses weekly against rib 41A by the spring back force. Making a comparison between the guiding unit 40 of the present invention that has a difference of height among ribs and a guiding unit that has no difference of height among ribs (i.e. a flat plate), with respect to the contact pressure at the central area, the contact pressure in the present guiding unit 40 at the central area (at rib 41A) is smaller than the contact pressure in the flat guiding unit.

As a result of the effect of the ribs 41A, 41B1, and 41B2, with respect to contact pressure, abnormal discharge by friction can be prevented from occurring at the central area of the A4 sheet, where a toner image is most apt to be formed, opposed to the rib 41A, although abnormal discharge still tends to occur at both width end areas of the A4 sheet opposed to the ribs 41B1 and 41B2 (although there tends not to be toner image at those ends). Accordingly, the guiding unit 40 guides the A4 sheet with maintaining toner image quality at both the central area and width end areas of the A4 sheet, because it tends to prevent the toner scattering by the abnormal discharge from occurring at the central area and there are margins to prevent toner scattering at the both width end areas. Even if toner images are at the both width end areas, as explained in the description about the effect of appearance of the toner scattering above, toner scattering caused by the end toner images does not stand out and a total image quality is substantially kept at a good level.

When the guiding unit 40 guides the A4 recording sheet in the landscape direction or the A3 recording sheet in the portrait direction to the subordinate guiding member 34, the A4 recording sheet or the A3 recording sheet is in contact with all five ribs 41A, 41B1, 41B2, 41C1, and 41C2. The A4 and A3 sheets are bent in the width direction orthogonal to the conveying direction of the sheet by the difference in heights among those five ribs. The width end areas of the A3 and A4 sheet press strongly the opposite ribs such as the ribs 41C1 and 41C2 by a spring back force of the bending sheet that tries to stabilize the sheet to a flat position, while the central areas of the A3 and A4 sheet press weekly opposite the rib 41A by the spring back force, and the middle area between the central area and width end area of those sheets also press weekly opposite the ribs 41B1 and 41B2 by the spring back force. Making a comparison between the guiding unit 40 of the present invention that has a difference of height among ribs and a guiding unit that has no difference of height among ribs (i.e. a flat plate), with respect to the contact pressure at the central area or the middle area, the contact pressure in the guiding unit 40 at the central areas (at ribs 41A, 41B1, 41B2) is smaller than the contact pressure in the flat guiding unit.

As a result of the effect of the ribs 41A, 41B1, 41B2, 41C1, and 41C2, with respect to the contact pressure, abnormal discharge by friction tends to be prevented from occurring at the central area or the middle area of the A3 and A4 sheets, where a toner image is most apt to be formed, opposed to the ribs 41A, 41B1, and 41B2, while abnormal discharge still tends to occur at both width end areas of the A4 and A3 sheets opposed to the ribs 41C1 and 41C2 (although there tends not to be a toner image at those areas). Accordingly, the guiding unit 40 guides the A4 and A3 sheets with maintaining toner image quality at all areas of the sheets, because it tends to prevent the toner scattering by the abnormal discharge from occurring at the central area and the middle area, and there are margins to prevent the toner scattering at the both width end areas. Even if toner images are at the both width end areas, as explained in the description about the effect of appearance of the toner scattering above, toner scattering caused by the toner images does not stand out and a total image quality is substantially kept at a good level.

As described in FIG. 1, the printer of the first embodiment of the present invention includes the discharge member 33. Even if this printer does not include the discharge member 33, toner image quality can be maintained by the guiding unit 40, but the printer with the discharge member 33 can maintain the image quality more effectively by the combined effect of the guiding unit 40 and the discharge member 33.

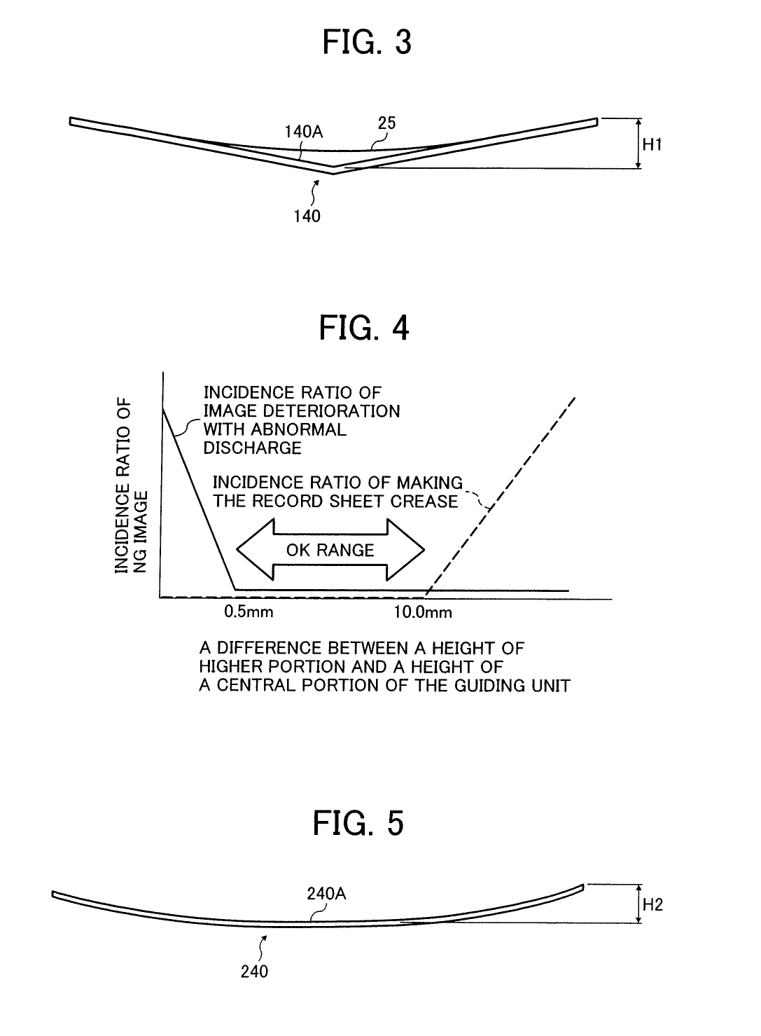

A second embodiment of this invention is the same printer of FIG. 1 as the first embodiment except with a different guiding unit, which is described as the guiding unit 140 in FIG. 3. Accordingly, a description of the common structure and process of the printer between the first embodiment and the second embodiment is omitted.

As shown in FIG. 3, the orthogonal cross section of a guiding unit 140 in the direction of conveying the recording sheet is a V-shape plate. A surface of the guiding unit 140 opposite to the recording sheet 25 is a guiding surface 140A. The closer to the central portion of the guiding surface 140A in the orthogonal direction to the direction of conveying the recording sheet 25, the lower the height of the guiding surface 140A. The guiding surface 140A guides the recording sheet 25 from the intermediate transfer belt 52 to the subordinate guiding member 34 as the both end portions of the V-shape which are higher than the height of the central portion are in contact with the side end areas of the recording sheet. The central portion of the guiding surface 140A is spaced away from the central area of the recording sheet 25. Accordingly, when the guiding unit 140 guides the recording sheet 25 on the surface of which there is a toner image, no friction occurs between the central portion of the guide surface 140A and the central area of the recording sheet 25.

When the guiding unit 140 guides the recording sheet 25, the recording sheet 25 is bent in the width direction orthogonal to the conveying direction of the sheet by the difference of the height between the end portions and the central portion of the guiding surface 140A. That difference is shown to as H1 in FIG. 3. The width end areas of the A4 sheet press strongly against the guiding surface 140A by a spring back force of the bending sheet 25 that stabilizes the sheet 25 to a flat position, while the central area of the sheet 25 does not press against the central portion of the guiding surface 140A. Making a comparison between the guiding unit 140 of the present invention which has the difference of the height and a guiding unit which has no difference of height (i.e., which is a flat plate), with respect to the contact pressure from the central area of the sheet 25 to the central portion of the guiding surface 140A, the contact pressure to the guiding surface 140A is smaller than the contact pressure in the flat guiding unit.

As a result of the effect of the V-shape guiding surface 140A, with respect to the contact pressure, the abnormal discharge by friction is tended to be prevented from occurring at the central area of the recording sheet 25, where a toner image is most apt to be formed, opposed to the central portion of the guiding surface 140A, while the abnormal discharge still tends to occur at both width end areas of the recording sheet opposed to the higher potions of the guiding surface 140A (although there tends to be no toner image at the end areas). Accordingly, the guiding unit 140 guides the recording sheet 25 while maintaining toner image quality at both the central area and width end areas of the sheet 25, because it tends to prevent the toner scattering by the abnormal discharge from occurring at the central area and there are margins to prevent the toner scattering at the both width end areas. Even if toner images are at the both width end areas, as explained in the description about the effect of appearance of the toner scattering above, the toner scattering caused by the toner images does not stand out and a total image quality is substantially kept at a good level.

Now follows an explanation of the relationship between an incidence ratio of image deterioration with abnormal discharge, an incidence ratio of making the recording sheet crease, and a difference between a height of a higher portion and a height of a central portion of the guiding unit. The explanation considers data whether the image deterioration occurs and data whether a crease occurs on the surface of the recording sheet 25 as the difference H1 of the guiding unit 140 is changed every time a certain number of A3 recording sheets 25 are conveyed in the portrait direction in the printer with the guiding unit 140. The chart of FIG. 4 is the result of the data used in the explanation. A horizontal axis of the chart of FIG. 4 corresponds to the range of changing the difference H1. A vertical axis of the chart of FIG. 4 corresponds to both the incidence ratio of image deterioration with abnormal discharge and the incidence ratio of making the recording sheet crease.

As seen in the chart of FIG. 4, it is preferable to make the difference H1 to be in the range 0.5 to 10 mm. When the difference H1 is less than 0.5 mm, the image deterioration with abnormal discharge occurs at the central area of the A3 recording sheet, because the effect of the V-shape of the guiding surface 140A is insufficient to prevent the abnormal discharge. When the difference H1 is more than 10 mm, a crease arises in the A3 recording sheet in the conveying direction after the A3 sheet passes through the fixing unit 30, because the A3 sheet is guided to the fixing unit 30 with being bent too much along the difference H1 of the height of the guiding surface 140A. When the A4 recording sheet is conveyed in the portrait direction, a preferable range of the difference H1 is larger than the range 0.5 to 10 mm. That is the case because the difference of the height between the central area and the width end area of the A4 recording sheet is still less than the difference of the A3 recording sheet when the difference H1 is a value more than 10 mm. Accordingly it is effective for both the A4 and A3 recording sheet to set the difference H1 to be in the range 0.5 to 10 mm.

As described in FIG. 1, the printer of the second embodiment includes the discharge member 33. Even if this printer does not include the discharge member 33, toner image quality can be maintained by the guiding unit 40, but the printer with the discharge member 33 can maintain the image quality more effectively by the combined effect of the guiding unit 40 and the discharge member 33.

A third embodiment of this invention is the same printer of FIG. 1 as the first embodiment except with a different guiding unit, which is described as the guiding unit 240 in FIG. 5. Accordingly, the description of the common structure and process of the printer between the first embodiment and the third embodiment is omitted.

As shown in FIG. 5, the orthogonal cross section of a guiding unit 240 in the direction of conveying the recording sheet is an arc plate. A surface of the guiding unit 240 opposite to the recording sheet 25 is a guiding surface 240A. The closer to the central portion of the guiding surface 240A in the orthogonal direction to the direction of conveying the recording sheet 25, the lower the height of the surface 240A. The guiding surface 240A guides the recording sheet 25 from the intermediate transfer belt 52 to the subordinate guiding member 34 as both end portions of the arc shape that are higher than the height of the central portion are in contact with the side end area of the recording sheet 25. The central portion of the guiding surface 240A is spaced away from the central area of the recording sheet 25. Accordingly, when the guiding unit 240 guides the recording sheet 25 on the surface of which there is a toner image, no friction occurs between the central portion of the guide surface 140A and the central area of the recording sheet 25.

When the guiding unit 240 guides the recording sheet 25, the recording sheet 25 is bent in the width direction orthogonal to the conveying direction of the sheet by the difference of the height between the end portions and the central portion of the guiding surface 240A. The difference is shown as H2 in FIG. 5. The width end areas of the A4 sheet press strongly against the guiding surface 240A by a spring back force of the bending sheet 25 that stabilizes the sheet 25 to a flat position, while the central area of the sheet 25 does not press against the central portion of the guiding surface 240A. Making a comparison between the guiding unit 240 of the present invention that has the difference of the height and a guiding unit that has no difference of height (i.e., is a flat plate), with respect to the contact pressure from the central area of the sheet 25 to the central portion of the guiding surface, the contact pressure to the guiding surface 240A is smaller than the contact pressure to the flat guiding unit.

As a result of the effect of the arc shape guiding surface 240A, with respect to the contact pressure, abnormal discharge by friction is tended to be prevented from occurring at the central area of the recording sheet 25, where a toner image is most apt to be formed, opposed to the central portion of the guiding surface 240A, while abnormal discharge still tends to occur at both width end areas of the recording sheet opposed to the higher potions of the guiding surface 140A (although there tends to be no toner image at those end areas). Accordingly, the guiding unit 140 guides the recording sheet 25 with maintaining toner image quality at both the central area and width end areas of the sheet 25, because it tends to prevent the toner scattering by the abnormal discharge from occurring at the central area and there are margins not causing the toner scattering at the both width end areas. Even if toner images are at the both width end areas, as explained in the description about the effect of appearance of the toner scattering above, the toner scattering caused by the toner images does not stand out and a total image quality is substantially kept at a good level.

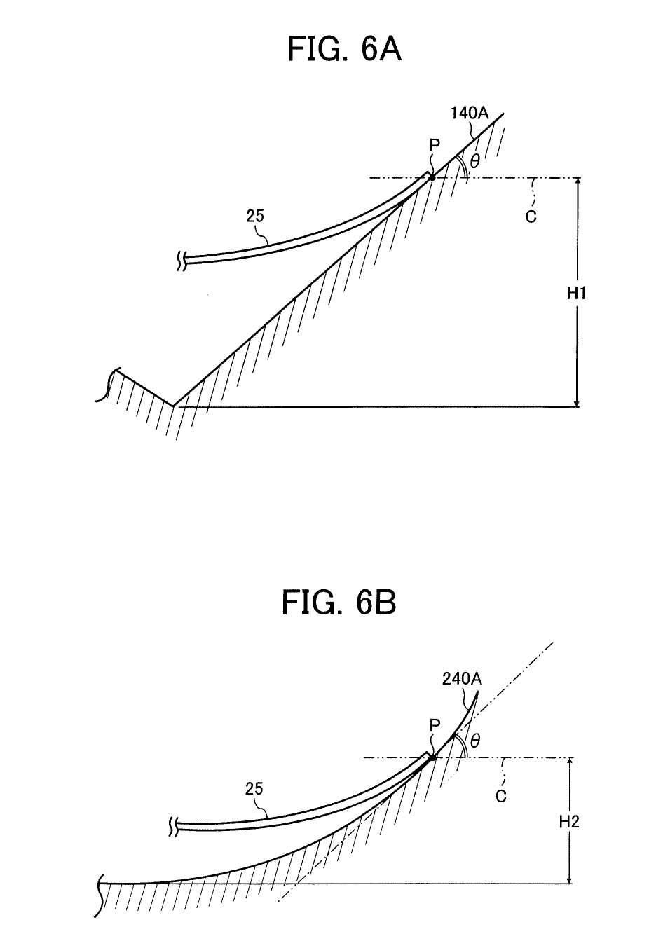

A description of a scale merit of the guiding units 140 and 240 referring to FIGS. 6A and 6B is now provided. FIG. 6A is a part diagram in which the side end of the recording sheet contacts the guiding unit 140 of FIG. 3 and FIG. 6B is a part diagram in which the side end of the recording sheet contacts the guiding unit 240 of FIG. 5. To prevent the toner image from image deterioration with abnormal discharge, the recording sheet preferably contacts the guiding surfaces only at its width side opposite to the surface with the transferred toner image, which is as distant as possible from the central area of the recording sheet. Accordingly it is preferable to make an incline of the part of the guiding surface, which is in contact with the width side, as large as possible. The contact part of the guiding surface is noted as P in FIGS. 6A and 6B. The incline is noted as θ in FIGS. 6A and 6B, at which an imaginary flat level C and a tangential plane at the contact part cross each other. When θ is made to be large, the differences H1 and H2, as described in FIGS. 6A and 6B respectively, are dependently made larger and the printer needs a larger space in which to place the guiding units 140 or 240. However, the difference H2 of the sheet guiding unit 240 is smaller than the difference H1 of the sheet guiding unit 140, as described in FIGS. 6A and 6B, in the case of the same incline θ. Accordingly, the printer equipped with the guiding unit 240 can be downsized more than the printer equipped with the guiding unit 140.

The effect of setting the difference H1 in the range 0.5 to 10 mm, which is described using FIG. 4, results in the guiding unit 140 having a V-shape and the guiding unit 240 having the arc shape.

Similarly as described in FIG. 1, this printer of the third embodiment includes the discharge member 33. Even if this printer does not include the discharge member 33, it can maintain toner image quality by utilizing the guiding unit 240, but the printer with the discharge member 33 can maintain the image quality more effectively by the combined effect of the guiding unit 240 and the discharge member 33.

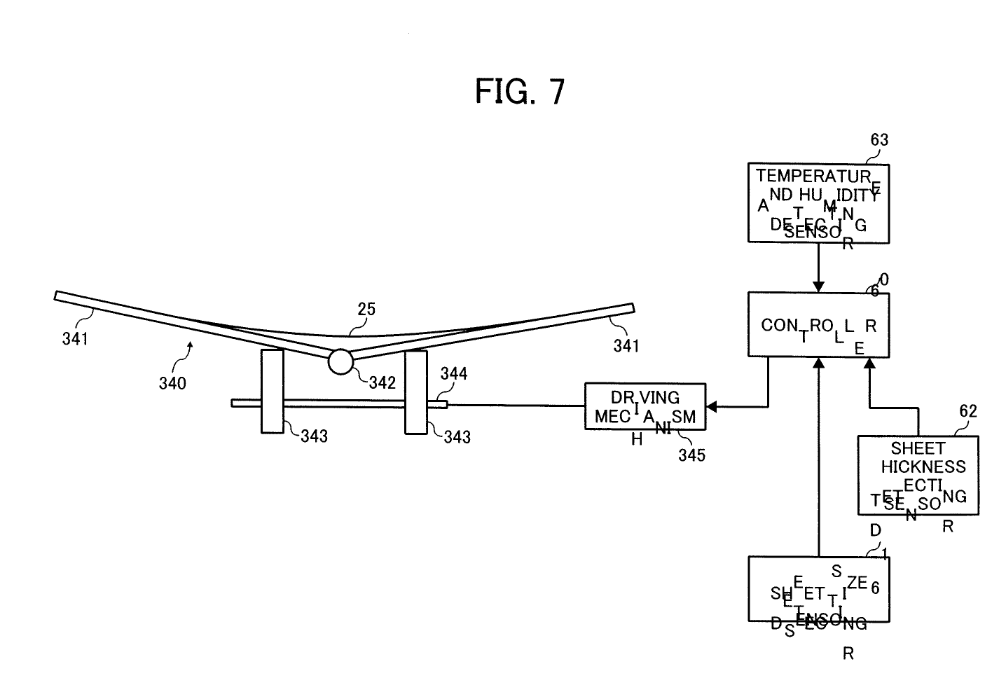

A fourth embodiment of this invention is the same printer of FIG. 1 of the first embodiment except with a different guiding unit, which is described as the guiding unit 340 in FIG. 7. Accordingly, a description of the common structure and process of the printer between the first embodiment and the fourth embodiment is omitted.

There are several factors that change an effective value of a difference between a height of a higher portion and a height of a central portion of the guiding unit. One of the factors is the different lengths in the width direction of the different size sheets, i.e. A3, A4, letter size, and legal size. Another is the different strengths against being bent based on differences of the kinds of sheets. Still another is the different environment in which the recording sheet is guided. The fourth embodiment of this invention automatically adjusts the difference between the height of the higher portion and the height of the central portion of the guiding unit to each effective value corresponding to such factors.

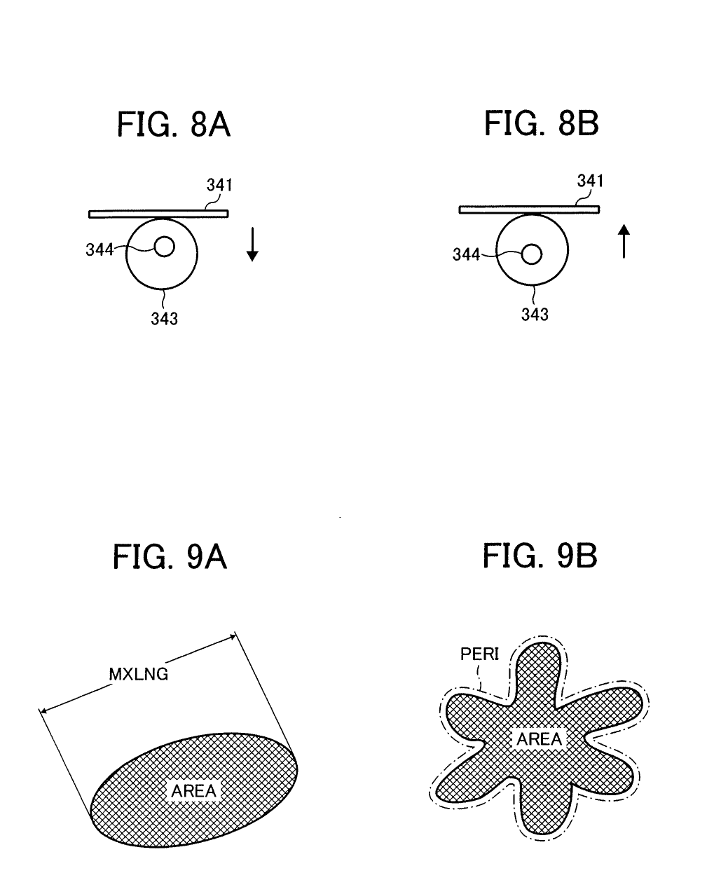

FIG. 7 is an orthogonal cross section of a guiding unit 340 of a fourth embodiment in the direction of conveying the recording sheet. FIG. 8A is a diagram representing one position of a cam 343. FIG. 8B is a diagram representing another position of the cam 343. Referring to FIG. 7, the guiding unit 340 includes two flat plates 341, an axis 342, two cams 343, a cam axis 344, a driving mechanism 345, a controller 60, a sheet size detecting sensor 61, a sheet thickness detecting sensor 62, and a temperature and humidity detecting sensor 63. The plates 341 and the axis 342 form a hinge structure and make a V-shape on which the recording sheet 25 is guided. The axis 344 extends in the direction of conveying the recording sheet from the intermediate transfer belt 52 to the subordinate guiding member 34 and is fixed to the main body of the printer. The two cams 343, the cam axis 344, and the driving mechanism 345 form a cam structure. The cams 343 support the flat plates 341 from under them respectively. The cam axis 344 unifies with the two cams 343. To adjust a difference between a height of an outer end of the flat plate 341 and a height of axis 342, the driving mechanism 345 drives the cam axis 344 to a desired angle. The controller 60 sends a control signal to the driving mechanism 345 that corresponds to a desired angle of the plates 341. The desired angle is decided by utilizing detected results from the sheet size detecting sensor 61, the sheet thickness detecting sensor 62, and the temperature and humidity detecting sensor 63. The operations of those three sensors are described below.

The position of the cam 343 of FIG. 8A makes the difference of the V-shape height the smallest, while the position of the cam 343 of FIG. 8B makes that difference the largest. To simplify, the difference of the V-shape height is abbreviated to the difference of V-shape height below. The difference of V-shape height is controlled by the turn of the cam axis 344. The difference of V-shape height may be controlled based on a detecting result of a detecting device that detects the difference of V-shape height directly (not shown).

Now a description of the influence of the width size of the recording sheet 25 to the toner image deterioration and the crease of the recording sheet is provided. When the width of the recording sheet 25 guided by the guiding unit 340 is large, a difference of a height between the central area and the width end of the recording sheet 25 is also large, which is formed by the sheet 25 being bent along the V-shape. This V-shape is made by the two flat plates 341 and the axis 342. When the difference of the height between the central area and the width end of the recording sheet 25 is large, both width end areas of the recording sheet contact the V-shape with large areas respectively, which tends to result in abnormal discharge from the V-shape to the recording sheet by friction. To prevent the both width end areas from contacting with the V-shape broadly, it is preferable to make the incline θ, as described in FIG. 6A, larger so only both the width end areas of the recording sheet contact the width end parts of the V-shape of the guiding unit 340 respectively. However, making the incline θ too large causes creases in the recording sheet 25. Accordingly, to make the incline θ effectually large, it is preferable to adjust the difference of V-shape height to be as large as possible, but not large enough to cause creases in the recording sheet 25.

A description of the effect of the sheet size detecting sensor 61 is now provided. The controller 60 receives outputs from the sheet size detecting sensor 61, which detects width sizes of the recording sheet 25. The controller 60 determines a preferable angle, at which the driving mechanism 345 drives the cam axis 344, corresponding to the result of the detected width. In detail, the preferable angle is determined as the difference of the height between the outer end of the flat plate 341 and the axis 342 to be as large as possible but not to cause creases in the recording sheet 25. The relationship between the preferable angle and the difference of the height per different width of the recording sheets can be determined by experiments or tests in advance.

A description of the influence of the sheet strength against being bent of the recording sheet 25 with respect to toner image deterioration and creasing of the recording sheet is now provided. The effective value of the difference between a height of the outer end of the flat plate 341 and a height of axis 342 can also be changed based on the kind of sheet, especially considering differences of the sheet strength against being bent. A thin sheet preferably results in a difference of the height between a central area and a width end area that is different from that of a thick sheet, even if the thin sheet and the thick sheet are made with the same material, and guided by a guiding unit 340 that forms the same V-shape respectively. Stronger sheets preferably result in a difference of the height between a central area and a width end area of the sheet that is different from that of other sheets of different strengths, that is even if the two different sheets have the same thickness, and guided by a guiding unit 340 which forms the same V-shape respectively. For a recording sheet whose strength is relatively smaller, a difference of a height between a central area and a width end area of the sheet is large and both width end areas of the recording sheet contact the V-shape with large areas respectively, which tends to result in abnormal discharge from the V-shape to the recording sheet by friction. To prevent the both width end areas from contacting with the V-shape broadly, it is preferable to make the incline θ, as described in FIG. 6A, larger so only the width end areas of the recording sheet contact the width end parts of the V-shape of the guiding unit 340 respectively. However, making the incline θ too large causes creases of the recording sheet 25. Accordingly, to make the incline θ effectually large, it is preferable to adjust the difference of the V-shape height to be as large as possible, but not to cause creases in the recording sheet 25.

A description of the effect of the sheet thickness detecting sensor 62 is now provided. The controller 60 receives outputs from the sheet thickness detecting sensor 62, which detects thickness of the recording sheet 25. In one non-limiting implementation, the sheet thickness detecting sensor 62 outputs a light beam, which passes through the recording sheet, and receives the beam after passing through the recording sheet. The smaller the beam received by the sensor 62, the greater the thickness of the sheet. The sensor 62 detects the thickness of the sheet corresponding to the beam amount, wherein correspondence with the thickness of the recording sheet is examined in advance.

The controller 60 can determine a preferable angle, at which the driving mechanism 345 drives the cam axis 344, corresponding to the result of the detected thickness. In detail, the preferable angle is determined as the difference of the height between the outer ends of the flat plates 341 and the axis 342 to be as large as possible, but not to cause creases in the recording sheet 25. The relationship between the preferable angle and the difference of the height per different thickness of the sheet can be determined by experiments or tests in advance.

A description of the influence of the environment to the toner image deterioration and the crease of the recording sheet is now provided. The effective value of the difference between a height of the outer ends of the flat plates 341 and a height of axis 342 is also changed based on differences of the environment in which the guiding unit 340 is guiding the recording sheet 25. In an atmosphere of low temperature and low humidity, a surface of the guiding unit 340 which guides the recording sheet 25 is apt to cause the abnormal discharge from the surface of the guiding unit 340 to the recording sheet 25 by friction. Accordingly, to reduce the friction between the recording sheet 25 and the surface of the guiding unit 340, it is preferable to make the incline θ, as described in FIG. 6A, larger so only both the width end areas of the recording sheet contact the width end parts of the V-shape of the guiding unit 340 respectively. However, making the incline θ too large causes creases of the recording sheet 25. Accordingly, to make the incline θ effectually large, it is preferable to adjust the difference of V-shape height to be as large as possible, but not to cause creases in the recording sheet 25.

The effect of the temperature and humidity detecting sensor 63 is now provided. The controller 60 receives outputs from the temperature and humidity detecting sensor 63, which is equipped near the sheet banking case 25A and that detects the temperature and humidity of the atmosphere. The result of detecting the temperature and humidity is sent from the sensor 63 to the controller 60. The controller 60 determines a preferable angle, at which the driving mechanism 345 drives the cam axis 344, corresponding to the result of the detected temperature and the humidity. In detail, the preferable angle is determined to make the difference of the V-shape height as large as possible, but not to cause creases in the recording sheet 25. The relationship between the preferable angle and the difference per different temperature and humidity can be determined by experiments or tests in advance.

The guiding unit 340 may change the V-shape height by results from any of the sensors 61, 62, or 63. Moreover, the guiding unit 340 may change the V-shape height by a preferable angle which the controller 60 determines based on any combination of results from the sensors 61, 62, or 63.

As described in FIG. 1, the printer of the fourth embodiment includes the discharge member 33. Even if this printer does not include the discharge member 33, it can maintain the toner image quality by utilizing the guiding unit 40, but the printer with the discharge member 33 can maintain the image quality more effectively by the combined effect of the guiding unit 40 and the discharge member 33.

The toner that is employed in all of the four embodiments will now be described. Preferably the volumetric average particle size of the toner is 3 to 8 μm, to reproduce fine dots of 600 dpi or more. Preferably the ratio (Dv/Dn) of the volume average particle size (Dv) and the number average particle size (Dn) is in the range 1.00 to 1.40. A sharper particle size distribution is displayed as (Dv/Dn) approaches 1.00. Toner of such a small particle size and narrow particle size distribution has a uniform distribution of toner charge, making it possible to obtain images of high quality with little blurring, and making it possible to increase the transfer rate in the ectrostatic transfer system. Preferably, the toner shape coefficient SF-1 is in the range 100 to 180 and the shape coefficient SF-2 is in the range 100 to 180. FIGS. 9A and 9B are diagrams showing diagrammatically the toner shape, given in explanation of this toner shape coefficient SF-1 and shape coefficient SF-2. The shape coefficient SF-1 shows the rounding ratio of the toner shape and is expressed by the following Equation (1).

SF-1={(MXLNG)2/AREA}×(100π/4) Equation (1).

This is a value obtained by dividing the square of the maximum length MXLNG of FIG. 9A produced by projection of the toner shown in FIG. 9A in a two-dimensional plane by the area AREA of FIG. 9A and multiplying by 100 π/4. If the value of SF-1 is 100, the shape of the toner is spherical; larger values of SF-1 indicate a more irregular shape.

Also, the shape coefficient SF-2 indicates the unevenness ratio of the toner shape and is expressed by the following equation (2).

SF-2={(PERI)2/AREA}×(100 π/4) Equation (2).

This value is obtained by dividing the square of the periphery PERI of FIG. 9B produced by projection of the toner shown in FIG. 9B in a two-dimensional plane by the area AREA of FIG. 9A and multiplying by 100 π/4. If the value of SF-2 is 100, unevenness is absent from the toner surface; increasing values of SF-2 indicate progressively more marked unevenness of the toner surface.

For measurement of the shape coefficients, specifically, a photograph of the toner is taken using a scanning electron microscope (e.g. S-800: manufactured by Hitachi Seisakusho), which is then introduced into an image analyzer (e.g. LUSEX 3: manufactured by Nireko) and analyzed to calculate the shape coefficients. When the shape of the toner approaches sphericity, the condition of contact of the toner particles with each other or between the toner particles and the photosensitive body becomes a point contact, so the adsorptive force between adjacent toner particles becomes weaker, so toner fluidity is increased. Also, the adsorptive force between the toner and the photosensitive body becomes weaker, so the transfer rate becomes higher. It is undesirable that either of the shape coefficients SF-1, SF-2 should exceed 180, since, if this happens, the transfer rate is lowered.

Suitably, the toner that is employed in an image forming apparatus according to this embodiment is toner obtained by subjecting a toner material liquid obtained by dispersing polyester prepolymer having a functional group containing at least a nitrogen atom, polyester, a coloring agent, and a release agent in an organic solvent to a cross-linking and/or elongation reaction in an aqueous solvent. The toner constituent material and a method of manufacturing the toner are now described below.

### Polyester

The polyester is obtained by a condensation polymerization reaction of a polyhydric alcohol compound and polyhydric carboxylic acid compound. Examples of polyhydric alcohol compounds (PO) that may be given include dihydric alcohols (DIO) and trihydric or more polyhydric alcohols (TO); preferably the (DIO) is employed alone, or in the form of a mixture of (DIO) and a small quantity of (TO). Examples of dihydric alcohols (DIO) that may be given include alkylene glycols (for example ethylene glycol, 1,2-propylene glycol, 1,3 propylene glycol, 1,4-butane diol, or 1,6-hexane diol); alkylene ether glycols (for example diethylene glycol, triethylene glycol, dipropylene glycol, polyethylene glycol, polypropylene glycol, or polytetramethylene ether glycol); alicyclic diols (for example 1,4 cyclohexane dimethanol, or hydrogenated bisphenol A); bisphenols (for example bisphenol A, bisphenol F, bisphenol S); alkylene oxides of the aforementioned alicyclic diols (for example ethylene oxide, propylene oxide or butylene oxide) adducts; and alkylene oxides of the aforementioned bisphenols (for example ethylene oxide, propylene oxide or butylene oxide) adducts. Of these, preferred examples are alkylene glycols of carbon number 2 to 12 and alkylene oxide adducts of bisphenols; particularly preferred examples are alkylene oxide adducts of bisphenols and joint use of these with alkylene glycols of carbon number 2 to 12. Examples of trihydric or more polyhydric alcohols (TO) include 3 to 8 or more-hydric polyhydric aliphatic alcohols(glycerol, trimethylol ethane, trimethylol propane, pentaerythritol or sorbitol); trihydric or more phenols (for example trisphenol PA, phenol novolac, or cresol novolac); or alkylene oxide adducts of the above trihydric or more polyphenols. As polyhydric carboxylic acids (PC), there may be mentioned by way of example dihydric carboxylic acids (DIC) and trihydric or more polyhydric carboxylic acids (TC); (DIC) used alone or a mixture of (DIC) with a small quantity of (TC) is preferable. As dihydric carboxylic acids (DIC) there may be mentioned by way of example alkylene dicarboxylic acids (for example succinic acid, adipic acid or sebacic acid); alkenylene dicarboxylic acids (for example maleic acid or fumaric acid); or aromatic dicarboxylic acids (for example, phthalic acid, isophthalic acid, terephthalic acid, or naphthalene dicarboxylic acid). Preferred examples of these are alkenylene carboxylic acids of carbon number 4 to 20 and aromatic dicarboxylic acids of carbon number 8 to 20. Examples of trihydric or more polyhydric carboxylic acids (TC) that may be mentioned include aromatic polyhydric carboxylic acids of carbon number 9 to 20 (for example trimellitic acid or pyromellitic acid). It should be noted that the reaction with the polyhydric alcohol (PO) may be conducted using an acid anhydride of the acids mentioned above or a low alkylene ester (for example methyl ester, ethyl ester, isopropyl ester) thereof as the polyhydric carboxylic acid (PC). Regarding the ratio of the polyhydric alcohol (PO) and polyhydric carboxylic acid (PC), the equivalents ratio [OH]/[COOH] of the hydroxide group [OH] and carboxylic group [COOH] is usually 2/1 to 1/1, preferably 1.5/1 to 1/1, and even more preferably 1.3/1 to 1.02/1.

Regarding the condensation polymerization reaction of the polyhydric alcohol (PO) and polyhydric carboxylic acid (PC), a polyester having hydroxyl groups is obtained by heating to 150 to 280° C., in the presence of a known esterification catalyst such as tetrabutoxy titanate or dibutyl tin oxide and distilling off the water that is produced under reduced pressure if necessary. Preferably the hydroxyl value of the polyester is at least 5, and the acid value of the polyester is normally 1 to 30, preferably 5 to 20. The acid value serves to facilitate negative charging capability and furthermore improves low temperature fixing performance, providing good affinity of the toner with the recording paper during fixing onto the recording paper. However, if the acid value exceeds 30, there tends to be an adverse effect on charging stability, in particular in respect of variations in the environment. Also, the weight average molecular weight of the polyester is 10,000 to 400,000, preferably 20,000 to 200,000. If the weight average molecular weight is less than 10,000, ability to withstand offset is adversely affected, which is undesirable. Also, if the weight average molecular weight exceeds 400,000, low temperature fixing performance are adversely affected, which is undesirable.

Apart from the unmodified polyester obtained by the above condensation polymerization reaction, the polyester preferably contains urea-modified polyester. Urea-modified polyester means that for example the terminal carboxylic groups and/or hydroxyl groups of the polyester obtained by the above condensation polymerization reaction are reacted with a polyhydric isocyanate compound (PIC), a polyester prepolymer (A) having isocyanate groups and molecular chains being obtained by cross-linking and/or elongation reaction with an amine. Examples of polyhydric isocyanate compounds (PIC) that may be employed include aliphatic polyhydric isocyanates (for example tetramethylene diisocyanate, hexamethylene diisocyanate, or 2,6 diisocyanate methyl caproate); alicyclic polyisocyanates (for example isophorone diisocyanate, or cyclohexyl methane diisocyanate); aromatic diisocyanates (for example tolylene diisocyanate or diphenyl methane diisocyanate); aromatic aliphatic diisocyanates (for example α,α,α′,α′-tetramethyl xylylene diisocyanate); isocyanates; or block copolymers of the aforesaid polyisocyanates with for example phenol derivatives, oximes or caprolactam; and block copolymers with two or more of these. The ratio of polyhydric isocyanate compounds (PIC) is usually 5/1 to 1/1, preferably 4/1 to 1.2/1, and even more preferably 2.5/1 to 1.5/1 in terms of the equivalents ratio [NCO]/[OH] of the isocyanate groups [NCO] and the hydroxyl groups [OH] of the polyester having the hydroxyl groups. If [NCO]/[OH] exceeds 5, low temperature fixing performance is adversely affected. If the mol ratio of [NCO] is less than 1, when urea-modified polyester is employed, the urea content in the ester becomes low and the ability to withstand hot offset is adversely affected. The content of polyhydric isocyanate compound (PIC) structural constituents in the polyester prepolymer (A) having an isocyanate group is usually 0.5 to 40 wt %, preferably 1 to 30 wt %, and even more preferably 2 to 20 wt %. If this content is less than 0.5 wt %, ability to withstand hot offset is adversely affected and this is also disadvantageous in terms of combining heat resistant storage performance and low temperature fixing performance. Also, low temperature fixing performance is adversely affected above 40 wt %. The number of isocyanate groups present per molecule in the polyester prepolymer (A) having an isocyanate group is usually at least one, preferably an average of 1.5 to 3, and even more preferably an average of 1.8 to 2.5. If there is less than one isocyanate group per molecule, the molecular weight of the urea-modified polyester becomes low and the ability to withstand hot offset is adversely affected.

Next, as examples of the amines (B) that are reacted with the polyester prepolymer (A) there may be mentioned dihydric amine compounds (B1), trihydric or more polyhydric amine compounds (B2), aminoalcohols (B3), aminomercaptans (B4), aminoacids (B5), and block combinations (B6) of the amino groups of B1 to B5. As dihydric amino compounds (B1), there may be mentioned as examples aromatic diamines (for example phenylene diamine, diethyl toluene diamine, or 4,4′-diamino diphenyl methane); alicyclic diamines (for example 4,4′-diamino-3,3′-dimethyl dicyclohexyl methane, diamine cyclohexane, or isophorone diamine); and for example aliphatic diamines (for example ethylene diamine, tetramethylene diamine or hexamethylene diamine). As trihydric or more polyhydric amine compounds (B2), there may be mentioned by way of example diethylene triamine, or triethylene tetra-amine. As aminoalcohols (B3), there may be mentioned by way of example ethanolamine or hydroxyethyl aniline. As aminomercaptans (B4) there may be mentioned by way of example aminoethyl mercaptan or aminopropyl mercaptan. As aminoacids (B5), there may be mentioned by way example amino propionic acid or aminocaproic acid. As block combinations (B6) of the amino groups of B1 to B5, there may be mentioned by way of example ketimine compounds, or oxazolidine compounds obtained from the amines of B1 to B5 above and ketones (for example acetone, methyl ethyl ketone, or methyl isobutyl ketone). Preferred examples of these amines (B) are B1 and mixtures of B1 with a small amount of B2. The ratio of amines (B) in terms of the equivalents ratio [NCO]/[NHx] of isocyanate groups [NCO] in the polyester prepolymer (A) having an isocyanate group and amino groups [NHx] in the amines (B) is usually 1/2 to 2/1, preferably 1.5/1 to 1/1.5, and even more preferably 1.2/1 to 1/1.2. If [NCO]/[NHx] exceeds 2 or is less than 1/2, the molecular weight of urea-modified polyester becomes low, adversely affecting ability to withstand hot offset.

Also, the urea-modified polyester may contain urea linkages and urethane linkages. The mol ratio of urea linkage content and urethane linkage content is usually 100/0 to 10/90, preferably 80/20 to 20/80, and even more preferably 60/40 to 30/70. If the mol ratio of urea linkages is less than 10%, ability to withstand hot offset is adversely affected. Urea-modified polyester may be manufactured by for example a one-shot method. The polyhydric alcohol (PO) and polyhydric carboxylic acid (PC) are heated to 150° to 280° C. in the presence of a known esterification catalyst such as tetrabutoxy titanate or dibutyl tin oxide, and polyester having hydroxyl groups is obtained by distilling off the water that is generated under reduced pressure if necessary. Next, this is reacted with polyhydric isocyanate (PIC) at 40° to 140° C., to obtain polyester prepolymer (A) having an isocyanate group. Further, this (A) is reacted with amine (B) at 0° to 140° C., to obtain urea-modified polyester. When the (PIC) is reacted, and when (A) and (B) are reacted, if necessary, a solvent may be employed. As solvents that may be employed, there may be mentioned by way of example aromatic solvents (for example toluene or xylene); ketones (for example acetone, methyl ethyl ketone, or methyl isobutyl ketone); esters (for example ethyl acetate); amides (for example dimethyl formamide, or dimethyl acetamide) and ethers (for example tetrahydrofuran), which are inert to isocyanates (PIC).

Also, in the cross-linking/and or elongation reaction of the polyester prepolymer (A) and amine (B), if necessary, the molecular weight of the urea-modified polyester obtained may be adjusted by using a reaction stopping agent. Examples of reaction stopping agents that may be given include monoamines (for example diethylamine, dibutylamine, butylamine, laurylamine) and block combinations of these (ketimine compounds). The weight average molecular weight of the urea-modified polyester is usually at least 10,000, preferably 20,000 to 10,000,000, and even more preferably 30,000 to 1,000,000. If the weight average molecular weight is less than 10,000, the ability to withstand hot offset is adversely affected. Regarding the number average molecular weight of for example the urea-modified polyester, there is no particular restriction if the previous unmodified polyester is employed and the urea-modified polyester may be of a number average molecular weight that makes it easy to obtain the aforesaid weight average molecular weight. If the urea-modified polyester is employed on its own, its number average molecular weight is usually 2000 to 15,000, preferably 2000 to 10,000, and even more preferably 2000 to 8000. If 20,000 is exceeded, low temperature fixing performance and luster when used in a full-color device are adversely affected. By using unmodified polyester and urea-modified polyester in combination, low temperature fixing performance and luster when used in a full-color image forming apparatus 100 are improved, so this is preferable rather than using urea-modified polyester on its own. It should be noted that “unmodified polyester” may include polyester that has been modified using chemical linkages apart from urea linkages. It is desirable for the point of view of low temperature fixing performance and hot offset performance that the unmodified polyester and urea-modified polyester should be at least partially mutually soluble. It is therefore preferable that the unmodified polyester and urea-modified polyester should be of similar composition. Also, regarding the weight ratio of unmodified polyester and urea-modified polyester, this is usually 20/80 to 95/5, preferably 70/30 to 95/5, and even more preferably 75/25 to 95/5, 80/20 to 93/7 being particularly preferred. If the weight ratio of urea-modified polyester is less than 5%, ability to withstand hot offset is adversely affected and this is also disadvantageous in terms of combining heat resistant storage performance and low temperature fixing performance.

The glass transition point (Tg) of binder resin containing unmodified polyester and urea-modified polyester is usually 45° to 65° C., preferably 45° to 60° C. If the glass transition point is less than 45° C., heat resistance of the toner is adversely affected and if it exceeds 65° C. low temperature fixing performance is insufficient. Also, the urea-modified polyester tends to be present at the surface of the toner matrix particles that are obtained, so heat resistant storage performance tends to be better than that of known polyester based toner, even though the glass transition point is low.

As coloring agents, all known dyes and pigments may be employed such as for example Carbon Black, Nigrosine, Iron Black, Naphthol Yellow S, and Hansa Yellow (10G, 5G, G), Cadmium Yellow, Yellow Iron Oxide, Yellow Ochre, Chrome Yellow, Titanium Yellow, Poly Azo Yellow, Oil Yellow, Hansa Yellow (GR, A, RN, R), Pigment Yellow L, Benzidine Yellow(G, GR), Permanent Yellow (NCG), Vulcan Fast Yellow (5G, R), Tartrazine Lake, Quinoline Yellow Lake, Anthrazan Yellow BGL, Isoindolinone Yellow, Red Iron Oxide, Red Lead, Lead Vermilion, Cadmium Red, Cadmium Mercury Red, Antimony Vermilion, Permanent Red 4R, Para Red, Fire Red, p-chloro o-nitro Aniline Red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Poly Azo Red, Chrome Vermilion, Benzidine Orange, Perynone Orange, Oil Orange, Cobalt Blue, Cerulean Blue, Alkali Blue Lake, Peacock Blue Lake, Victoria Blue Lake, Metal-free Phthalocyanin Blue, Phthalocyanin Blue, Fast Sky-blue, Indanthrene Blue (RS, BC), Indigo, Ultramarine, Navy-blue, Anthraquinone Blue, Fast Violet B, Methyl Violet Lake, Cobalt Violet, Manganese Violet, Dioxane Violet, Anthraquinone Violet, Chrome Green, Zinc Green, Chromium Oxide, Viridian, Emerald Green, Pigment Green B, Naphthol Green B, Green Gold, Acid Green Lake, Malachite Green Lake, Phthalocyanin Green, Anthraquinone Green, Titanium Oxide, Zinc White, Lithopone and mixtures of these.

The content of coloring agent is usually 1 to 15 wt % with respect to the toner, preferably 3 to 10 wt %. The coloring agent may also be employed in the form of a master batch combined with the resin. In the manufacture of a master batch, or as a binder resin kneaded with the master batch, there may be employed for example the following, either alone or as a mixture: polymers of styrene and derivatives thereof or copolymers of these with vinyl compounds such as polystyrene, poly-p-chlorostyrene, or polyvinyl toluene, or polymethyl methacrylate, polybutyl methacrylate, polyvinyl chloride, polyethylene, polypropylene, polyester, epoxy resin, epoxy polyol resin, polyurethane, polyamide, polyvinyl butyral, polyacrylate resin, rosin, modified rosin, terpene resin, aliphatic or alicyclic hydrocarbon resin, aromatic petroleum resin, chlorinated paraffin, or paraffin wax.

### Charging Control Agent

As a charging control agent, known charging control agents may be employed such as for example nigrosine dyes, triphenylmethane dyes, chromium-containing metallic complex dyes, molybdenum acid chelate pigment, rhodamine dyes, alkoxyamines, quaternary ammonium salts (including fluorine-modified quaternary ammonium salts), alkylene amides, phosphorus either alone or in the form of a compound thereof, tungsten either alone or in the form of a compound thereof, fluorine based activating agents, metal salicylates, or metal salicylate derivatives. Specific examples are the nigrosine-based dye Bontoron 03, the quaternary ammonium salt Bontoron P-51, the metal containing azo dye Bontoron S-34, the oxynaphthoate-based metallic complex E-82, the metal salicylate complex E-84, the phenol-based condensation product E-89 (the above are manufactured by Orient Chemical Industries Inc), the quaternary ammonium salt molybdenum complexes TP-302 and TP-415 (the above are manufactured by Hodogaya Chemical Industries Inc.), the quaternary ammonium salt Copy Charge PSY VP 2038, the triphenylmethane derivative Copy Blue PR, the quaternary ammonium salt Copy Charge NEG VP 2036, Copy Charge NX VP 434 (the above is manufactured by Hoechst Inc.), LRA at 901, the boron complex LR-147 (manufactured by Japan Carlit), copper phthalocyanin, perylene, quinacridone, azo based pigments, or, in addition, high molecular weight compounds having functional groups such as sulfonate groups, carboxylate groups, or quaternary ammonium salts. Of these, in particular substances that control the toner to negative polarity are preferably employed. The amount of charging control agent used is determined by the method of toner manufacture including the type of binder resin, whether or not additives are employed as required, and the method of dispersal and so cannot be uniquely specified, but preferably is employed in the range 0.1 to 10 weight parts with respect to 100 weight parts of binder resin. Preferably the range may be 0.2 to 5 weight parts. If 10 weight parts are exceeded, the charging of the toner tends to be too large and the benefit of the charging control agent is diminished, electrostatic adsorptive force with respect to the developing roller is increased, the fluidity of the developer drops, and the image density decreases.

### Release Agent

Release agents, constituted by low melting point wax of melting point 50° to 120° C., act between the fixing roller and the toner interface and act more effectively as release agents in dispersion in the binder resin: in this way, release can be achieved without coating the fixing roller with a release agent such as oil. The following may be mentioned by way of example as constituents of such waxes: plant waxes such as camauba wax, cotton wax, wood wax or rice wax, animal wax such as beeswax or lanolin, mineral wax such as ozokerite or cercine, and paraffin, microcrystalline or petrolatam or other petroleum wax. Also, apart from these natural waxes, synthetic hydrocarbon waxes such as Fischer-Tropsch-wax or polyethylene wax, or synthetic waxes such as esters, ketones, or ethers may be mentioned by way of example. In addition, 2-hydroxystearic acid amide, stearic acid amide, phthalic anhydride imide, fatty acid amides of chlorinated hydrocarbons and the like or homopolymers or copolymers of polyacrylate, such as poly-n- stearyl methacrylate or poly-n-lauryl methacrylate, which are crystalline polymer resins of low molecular weight (for example n-stearylacrylate- ethyl methacrylate copolymer) and the like and crystalline polymers having alkyl groups with long side chains and the like may be employed. The charging control agents and release agents may also be dissolved and kneaded with a master batch and binder resin or may of course be added during dissolving and dispersal of the organic solvent.

### Externally Added Agents

Fine inorganic particles are preferably employed as externally added agents for promoting fluidity of the toner particles and assisting development performance and charging performance. The primary particle size of such fine inorganic particles is preferably 5×10−3 to 2 μm, 5×10−3 to 0.5 μm in particular being preferred. Also, the relative surface area obtained by the BET method is preferably 20 to 500 m2/g. The ratio in which such fine inorganic particles are employed is preferably 0.01 to 5 wt % of the toner; in particular, 0.01 to 2.0 wt % is preferable. Specific examples of such fine inorganic particles that may be mentioned include silica, alumina, titanium oxide, barium titanate, magnesium titanate, calcium titanate, strontium titanate, zinc oxide, tin oxide, silica sand, clay, mica, silica ash, diatomaceous earth, chromium oxide, cerium oxide, red iron oxide, antimony trioxide, magnesium oxide, zirconium oxide, barium sulfate, barium carbonate, calcium carbonate, silicon carbide, or silicon nitride. Of these, it is preferable to employ fine hydrophobic silica particles and fine hydrophobic titanium oxide particles together as a fluidity enhancing agent. In particular, if stirring and mixing are performed using both of these types of fine particles with average particle size of 5×10-2 μm or less, the electrostatic force and the Van der Waals force with the toner are enormously improved, with the result that separation of the fluidity enhancing agent from the toner does not occur even though the toner is subjected to stirring and mixing in the interior of the developing device, which are performed to obtain the desired charging level and high image quality can be obtained in which “fireflies” or the like do not appear and further reduction in the amount of toner left behind after transfer can be achieved. While fine titanium oxide particles are excellent in regard to promoting environmental stability and stability of image density, they tend to have an adverse effect on the rise characteristic of charging; as a result, if a larger amount of fine silica particles is added than the added amount of fine titanium oxide particles, the effect of side effects thereof appears to become considerable. However, in a range of added amount of fine hydrophobic silica particles and fine hydrophobic titanium oxide particles of 0.3 to 1.5 wt %, the desired charging rise characteristic is obtained without impairing the magnitude of the charging rise characteristic i.e., even when repeated copying is performed, stable image quality is obtained

Next, a method of manufacturing toner will be described. Although a preferred method of manufacture is illustrated, there is no restriction to this.

### Method of Manufacturing Toner

1) Toner material is created by dispersing coloring agent, unmodified polyester and a polyester prepolymer having isocyanate groups and a release agent in an organic solvent. It is desirable from the point of view of facilitating removal of the organic solvent after forming the toner matrix particles that the organic solvent should be volatile with a boiling point of less than 100° C. Specific examples of organic solvents that may be used, alone or in a combination of two or more, include toluene, xylene, benzene, carbon tetrachloride, methylene chloride, 1,2-dichloromethane, 1,1,2-trichloroethane, trichloroethane diethylene, chloroform, monochlorobenzene, dichloroethylidene, methyl acetate, ethyl acetate, methyl ethyl ketone, or methyl isobutyl-ketone. In particular, aromatic solvents such as toluene or xylene and halogenated hydrocarbons such as methylene chloride, 1,2-trichloroethane, chloroform or carbon tetrachloride are preferred. The amount of organic solvent used is usually 0 to 300 weight parts with respect to 100 weight parts of polyester prepolymer, preferably 0 to 100 weight parts and even more preferably 25 to 70 weight parts.

2) The toner material liquid is emulsified in an aqueous medium in the presence of a surfactant or fine resin particles. The aqueous medium may be for example water on its own, or may contain an organic solvent such as alcohol (for example methanol, isopropyl alcohol, or ethylene glycol), dimethyl formamide, tetrahydrofuran, a Cellosolve (for example methyl Cellosolve), or low ketone, for example acetone or methyl ethyl ketone). The amount of aqueous medium used with respect to 100 weight parts of toner material liquid is usually 50 to 2000 weight parts, preferably 100 to 1000 weight parts. If the amount used is less than 50 weight parts, the dispersion condition of the toner material liquid is poor and toner particles of the prescribed particle size are not obtained. If it exceeds 20,000 weight parts, this is uneconomic. Also, to improve dispersion in the aqueous medium, there may be added a suitable dispersal agent such as a surfactant or fine resin particles. Examples of surfactants that may be given include anionic surfactants such as alkylene benzene sulfonate, a-olefin sulfonate or phosphate esters, cationic surfactants such as amine salts such as alkylamine salts, aminoalcohol fatty acid derivatives, polyamine fatty acid derivatives, or imidazoline, or quaternary ammonium salts such as alkyl trimethyl ammonium salts, dialkyl dimethyl ammonium salts, alkylamine dimethyl benzyl ammonium salts, pyridinium salts, alkyl isoquinolinium salts or benzethonium chloride, non-ionic surfactants such as fatty acid amide derivatives, polyhydric alcohol derivatives, or amphoteric surfactants such as for example alanine, dodecyl di(aminoethyl) glycine, di(octylaminoethyl)glycine or N-alkyl-N,N-dimethyl ammonium betaine. Also, by using a surfactant having a fluoroalkyl group, the benefit thereof can be improved even in extremely small quantity. Examples that may be given of anionic surfactants having a fluoroalkyl group that may preferably be used include fluoroalkyl carboxylic acids of carbon number 2 to 10 and metallic salts thereof, disodium perfluoro-octane sulfonyl glutamate, sodium 3-[ω-fluoroalkyl (C6 to C11) oxy]-1-alkylamines (C3 to C4), sodium 3-[ω-fluoroalkanoyl (C6 to C8)-N-ethylamino]-1-propane sulfonate, fluoroalkyl(C11 to C20) carboxylic acids and metallic salts thereof, erfluoroalkyl carboxylic acids (C7 to C13) and metallic salts thereof, perfluoroalkyl (C4 to C12) sulfonic acids and metallic salts thereof, perfluoro octane sulfonic acid diethanolamide, N-propyl-N-(2-hydroxyethyl) perfluoro octane sulfonamide, perfluoroalkyl (C6 to C10) sulfonamide propyl trimethyl ammonium salts, perfluoroalkyl (C6 to C10)-N-ethyl sulfonyl glycine salts, or monoperfluoroalkyl (C6 to C16) ethyl phosphoric acid esters. As product names there may be mentioned by way of example Surflon S-111, S-112, S-113 (manufactured by Asahi glass Inc), Fluorad FC-93, FC-95, FC-98, FC-129 (manufactured by Sumitomo 3M), Unidine DS-101, DS-102 (manufactured by Daikin Industries), Megaface F-110, F-120, F-113, F-191, F-812, F-833 (manufactured by Dainippon Ink and Chemicals Inc), Ektop EF-102, 103, 104, 105, 112, 123A, 123B, 306A, 501, 201, 204, (manufactured by Tochem Products Inc), or Futargent F-100, F 150 (manufactured by Neos, Inc.). Also, as cationic surfactants, there may be mentioned by way of example primary or secondary aliphatic having a fluoroalkyl group or secondary aminoacids, aliphatic quaternary ammonium salts such as perfluoroalkyl (C6 to C10) sulfonamide propyl trimethyl ammonium salts, benzalkonium salts, benzethonium chloride, pyridinium salts, imidazolinium salts, or, as commercial names, Surflon S-121 (manufactured by Asahi Glass), Fluorad FC-135 (manufactured by Sumitomo 3M), Unidine DS-202 (manufactured by Daikin Industries), Megaface F-150, F-824 (manufactured by Dainippon Ink and Chemicals Inc.), Ektop EF-132 (manufactured by Tochem Products Inc.), or Futargent F-300, (manufactured by Neos, Inc.). Fine resin particles may be added in order to stabilize the toner matrix particles formed in the aqueous medium. Preferably, these are added such that the covering factor with which they are present on the surface of the toner matrix particles is in the range 10 to 90%. Examples of these that may be mentioned include fine polymethyl methacrylate particles of 1 μm and 3 μm, fine polystyrene particles of 0.5 μm and 2 μm, fine (styrene-acrylonitrile) particles of 1 μm, or, as commercial names, PB-200H (manufactured by Kao, Inc.), SGP (manufactured by Soken, Inc.), Technopolymer SB (manufactured by Sekisui Kaseihin Kogyo), SGP-3G (manufactured by Soken Inc.) and Micropearl (manufactured by Sekisui Fine Chemicals Inc.). Also, inorganic compound dispersants such as calcium triphosphate, calcium carbonate, titanium oxide, colloidal silica, or hydroxyapatite may be employed. Dispersed droplets may be stabilized by using a polymeric protective colloid as a dispersion agent in combination with the above-mentioned fine resin particles or inorganic compound dispersion agents. Examples that may be used include acids such as acrylic acid, methacrylic acid, α-cyanoacrylic acid, α-cyanomethacrylic acid, itaconic acid, crotonic acid, flumaric acid, maleic acid or maleic anhydride, or (meth)acrylate-based monomers containing a hydroxyl group, for example β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid ester, triethylene glycol mono methacrylic acid ester, glycerol monoacrylic acid ester, glycerol monomethacrylic acid ester, N-methylol acrylamide, or N-methylol methacrylamide, vinyl alcohol or ethers of vinyl alcohol, for example vinyl methyl ether, vinyl ethyl ether, or vinyl propyl ether, or esters of compounds including vinyl alcohol and carboxyl groups, for example vinyl acetate, vinyl propionate, or vinyl lactate, acrylamide, methacrylamide, diacetone acrylamide or methylol compounds thereof, acid chlorides such as acrylic acid chloride, methacrylic acid chloride, or nitrogen-containing compounds such as vinyl pyridine, vinyl pyrrolidone, vinyl imidazole, or ethylene imine, or heterocyclic compounds or homopolymers or copolymers thereof, polyoxyethylenes such as polyoxyethylene, polyoxypropylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearylphenyl ester, or polyoxyethylene nonylphenyl ester, or celluloses such as cellulose, hydroxyethyl cellulose, or hydroxypropyl cellulose. There is no particular restriction regarding the method of dispersal and known equipment such as low-speed shearing equipment, high-speed shearing equipment, frictional equipment, high-pressure jet equipment or ultrasonic equipment may be employed. Of these, high-speed shearing equipment for producing a dispersion of particle size 2 to 20 μm is preferable. If a high-speed sheering type dispersion machine is employed, there is no particular restriction regarding the speed of rotation thereof, but usually this will be 1000 to 30,000 rpm, preferably 5000 to 20,000 rpm. There is no particular restriction regarding the dispersal time, but, in the case of the batch system, usually this will be 0.1 to 5 minutes. For the temperature during dispersion, usually a temperature of 0° to 150° C. (under pressure), preferably 40° to 98° C. is employed.

3) At the same time as the manufacture of an emulsion, amines (B) are added and a reaction is conducted with the polyester prepolymer (A) having an isocyanate group. This reaction is accompanied by cross-linking and/or elongation of the molecular chains. The reaction time is selected in accordance with the reactivity of the polyester prepolymer (A) having an isocyanate group structure and the amines (B), but is usually 10 minutes to 40 minutes, preferably 2 to 24 hours. The reaction time is usually 0° to 150° C., preferably 40° to 98° C. Also, if required, a known catalyst may be employed. Specific examples that may be given include dibutyl tin laurate, or dioctyl tin laurate.

4) After completion of the reaction, the organic solvent is removed from the emulsified dispersion (reactants) and the toner matrix particles are obtained by washing and drying. To remove the organic solvent, the entire system may be gradually elevated in temperature under laminar-flow stirring conditions, strong stirring being applied in a fixed temperature range, followed by removal of solvent to manufacture spindle shaped toner matrix particles. Also, if a substance that is capable of dissolving in acid or alkali, such as calcium phosphate or the like, is employed as a dispersion stabilizer, the calcium phosphate is removed from the toner matrix particles by a method such as washing with water after dissolving the calcium phosphate using acid such as hydrochloric acid. Apart from this, removal may be performed by an operation such as decomposition using an enzyme.

5) Toner is then obtained by absorbing a charge stabilizer in the toner matrix particles obtained as above, followed by applying fine inorganic particles such as fine silica particles or fine titanium oxide particles externally. The absorption of the charge stabilizer and external application of the fine inorganic particles may be performed by a known method using for example a mixer.

In this way, toner of small particle size and sharp particle size distribution can easily be obtained. In addition, it is possible to control the shape from a spherical shape to a rugby ball shape and, further, to control the surface morphology from a smooth morphology to a wrinkled “pickled plum” shape, by applying strong stirring in the step of removing the organic solvent. It can be shown by the following shape definition that the toner shape in the present embodiment is substantially spherical shaped.

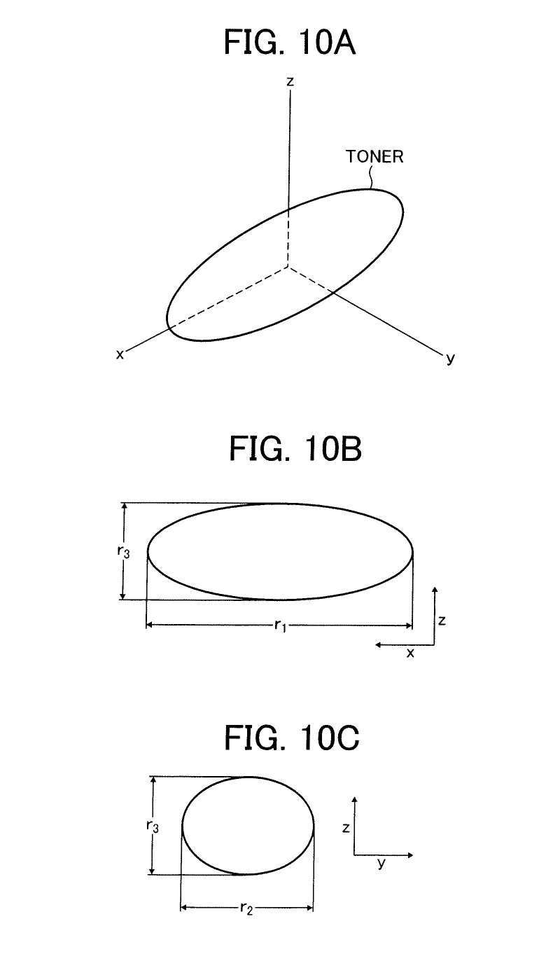

FIGS. 10A to 10C are diagrams showing diagrammatically the toner shape according to the present invention. In FIGS. 10A-10C, substantially spherical shaped toner is defined as having a long axis r1, short axis r2, thickness r3 (where r1 □ r2 □ r3). Toner according to the present embodiment preferably has a ratio (r2/r1) of the long axis and short axis (see FIG. 10C) in the range 0.5 to 1.0, and a ratio (r3/r2) of the thickness and short axis (see FIG. 10B) in the range 0.7 to 1.0. If the ratio of the long axis and short axis (r2/r1) is less than 0.5, dot reproducibility and transfer efficiency are adversely affected due to the departure from sphericity and high image quality is not obtained. Also, if the ratio of the thickness and a short axis (r3/r2) is less than 0.7, the particles become close to a flat shape and a high transfer rate as in the case of spherical toner is not obtained. In particular, if the ratio of the thickness and short axis (r3/r2) is 1.0, the particle becomes a rotary body whose rotary axis is the long axis, and fluidity of the toner can thereby be improved. Each of r1, r2 and r3 were measured by observation by image pickup using a scanning electron microscope (SEM), varying the angle of the field of view.

Obviously, numerous modifications and variations of the present invention are possible in light of the above teachings. It is therefore to be understood that within the scope of the appended claims, the invention may be practiced otherwise than as specifically described herein.

1. An image forming apparatus, comprising:
an image carrier configured to carry a toner image;
a transfer unit configured to transfer the toner image from said image carrier to a surface of a recording sheet;
a fixing unit configured to fix the toner image onto the recording sheet;
a guiding unit located between said transfer unit and said fixing unit, said guiding unit comprising a guiding part configured to guide the recording sheet from said transfer unit to said fixing unit with a side opposite to the surface of the recording sheet contacting with said guiding part,
wherein said guiding part includes higher end portions having a greater height than at a central portion thereof.

2. The image forming apparatus according to claim 1,
wherein said higher portions contact with side end areas of the recording sheet while said central portion substantially contacts a central area of the recording sheet.

3. The image forming apparatus according to claim 1,
wherein said guiding part includes a plurality of ribs extending orthogonal to a conveying direction of the recording sheet,
said higher portions include end ribs of said plurality of ribs, and
said central portion includes a central rib of said plurality of ribs.

4. The image forming apparatus according to claim 1, further comprising:
a latent image forming unit configured to form a latent image on the image carrier; and
a developing unit configured to develop the latent image with a toner,
wherein volume average particle size of said toner is 3 to 8 μm and ratio (Dv/Dn) of volume average particle size (Dv) and number average particle size (Dn) is in a range of 1.00 to 1.40.

5. The image forming apparatus according to claim 4, wherein said toner has a shape factor SF-1 of at least 100 but no more than 180 and a shape factor SF-2 of at least 100 but no more than 180.

6. The image forming apparatus according to claim 5,
wherein said toner is obtained by cross linkage and/or elongation reaction, in an aqueous medium, of toner material in which polyester prepolymer having at least a functional group containing a nitrogen atom, polyester, coloring agent, and release agent are dispersed in an organic solvent.

7. The image forming apparatus according to claim 1,
wherein said higher portions contact with side end areas of the recording sheet while said central portion is spaced apart from a central area of the recording sheet.

8. The image forming apparatus according to claim 7,
wherein an orthogonal cross section of said guiding part to a direction of conveying the recording sheet has a V-shape.

9. The image forming apparatus according to claim 7,
wherein an orthogonal cross section of said guiding part to a direction of conveying the recording sheet has an arc shape.

10. The image forming apparatus according to claim 8, further comprising:
an adjusting unit configured to adjust a height difference between the height of said higher portions and the height of said central portion.

11. The image forming apparatus according to claim 10.
wherein said adjusting unit adjusts said height difference to be in a range 0.5 to 10 mm.

12. The image forming apparatus according to claim 10, further comprising:
a first detecting unit configured to detect a width of the recording sheet;
wherein said adjusting unit adjusts said height by difference based on the detected width of the recording sheet.

13. The image forming apparatus according to claim 10, further comprising:
a detecting unit configured to detect a property of the recording sheet;
wherein said adjusting unit adjusts said height difference based on the detected property of the recording sheet.

14. The image forming apparatus according to claim 13, wherein the detected property is a thickness of the recording sheet.

15. The image forming apparatus according to claim 10, further comprising:
a third detecting unit configured to detect temperature of an atmosphere in the image forming unit;
wherein said adjusting unit adjusts said height difference based on the detected temperature.

16. The image forming apparatus according to claim 10, further comprising:
a fourth detecting unit configured to detect humidity of an atmosphere in the image forming unit;
wherein said adjusting unit adjusts said height difference based on the detected humidity.

17. The image forming apparatus according to claim 7, further comprising:
a latent image forming unit configured to form a latent image on the image career; and
a developing unit configured to develop the latent image with a toner,
wherein volume average particle size of said toner is 3 to 8 μm and the ratio (Dv/Dn) of volume average particle size (Dv) and number average particle size (Dn) is in a range of 1.00 to 1.40.

18. The image forming apparatus according to claim 17, wherein said toner has a shape factor SF-1 of at least 100 but no more than 180 and a shape factor SF-2 of at least 100 but no more than 180.

19. The image forming apparatus according to claim 18,
wherein said toner is obtained by cross linkage and/or elongation reaction, in an aqueous medium, of toner material in which polyester prepolymer having at least a functional group containing a nitrogen atom, polyester, coloring agent, and release agent are dispersed in an organic solvent.

20. An image forming apparatus, comprising:
means for carrying a toner image;
means for transferring the toner image from said means for carrying to a surface of a recording sheet;
means for fixing the toner image onto the recording sheet;
means for guiding the recording sheet from said means for transferring to said means for fixing with a side opposite to the surface of the recording sheet contacting with said means for guiding,
wherein said means for guiding has a greater height at end portions than at a central portion thereof.
